(19) United States
(12) Patent Application Publication
(10) Pub. No.: US 2013/0015825 A1
(43) Pub. Date: Jan. 17, 2013

(54) FLYWHEEL APPARATUS

(71) Applicant: Keith Pullen, London (GB)

(72) Inventor: Keith Pullen, London (GB)

(73) Assignee: THE CITY UNIVERSITY, London (GB)

(21) Appl. No.: 13/522,710

(22) PCT Filed: Jan. 18, 2011
(86) PCT No.: PCT/GB2011/000053

§ 371 Date: Sep. 25, 2012

(30) Foreign Application Priority Data
Jan. 18, 2010 (GB) 1000751.6

(51) Int. Cl. H02K 7/02; H02K 7/09; H02P 31/00

(52) U.S. Cl. 322/4; 310/74; 318/161; 310/156.04; 74/572.1; 74/572.11; 74/572.12

(57) ABSTRACT

The present invention provides a flywheel apparatus for use as an energy storage system, the apparatus comprising: a housing unit having a base; a flywheel assembly mounted within the housing unit, the assembly comprising a flywheel supported by a rotatable axle arranged to enable rotation of the assembly within the housing, the axle defining an axis of rotation; stabilising means located within the housing unit arranged to stabilise rotation of the flywheel assembly about the rotation axis; and levitation means arranged to levitate the flywheel assembly above the base of the housing unit, in order to create a clearance between the flywheel assembly and the base of the housing unit.

### TECHNICAL FIELD

The present invention relates to the field of alternative energy storage technologies, and specifically to alternatives to electrical energy storage solutions such as electrochemical batteries and ultracapacitors.

### BACKGROUND

A large proportion of the world's population amounting to 1.6 billion people are without access to electricity. The implication of this is that once daylight ceases, their world is plunged into darkness with the only alterative being kerosene lamps which are both dangerous and expensive to run due to the need for oil. Lighting after dark is vital for education when nearly all daylight hours are required for manual work in what are mainly agricultural rural societies. Even where grid supplied electricity is available such as in urban and peri-urban environments, it can be highly intermittent leading to similar problems. Some progress has been made in the development of lamps operating from batteries and charged by solar voltaic cells but this is totally reliant on the electrochemical battery which has limited life, is expensive and cannot be repaired. Obtaining high life from batteries requires great care in terms of charging and discharging habits. Every user of a laptop, PDA or mobile knows that batteries have a finite life even if charging is carried out carefully as the manufacturer recommends. It is not practical to expect such care to be taken by people who are not as used to technology. Once the battery is spent and can no longer be recharged, recycling is less of a practical option in a developing world where it will be most likely dumped along with the pollutant chemicals. Batteries are generally imported and there is little opportunity for value added in terms of business for the developing country.

Alternative solutions have been proposed which comprise a flywheel. A flywheel is a mechanical device comprised of a wheel capable of rotating at high speed and storing energy by virtue of its momentum. Effectively, input energy is stored as rotational kinetic energy in the flywheel. Typically, a flywheel energy storage device comprises a flywheel rotor, and a motor-generator for power input/output. Electrical energy may be stored and recovered via a motor/generator. Although such a device is heavier and bulkier than a battery, the device life is much greater and it is possible to repair and maintain it within a low technology workshop. It is even possible to manufacture some of the parts locally.

There has been much research into flywheel energy storage, particularly to meet the needs of vehicle and large-scale energy storage requirements. The main barrier to exploitation of this storage technique is the ability to mount the flywheel in a low-cost system of sufficient life, that does not invoke excessive run-down losses. Current known prior art flywheel energy storage solutions have been unsuccessful at presenting a serious alternative to traditional electrochemical batteries, due to the inefficiencies inherent in the designs of such systems, and particularly the losses due to friction.

Low friction bearings in the form of active magnetic bearings have been used in known prior art systems. However, such solutions are too expensive for many applications since a powered control circuit is required, which also significantly increases both the production and maintenance complexity of such systems. As a result, such prior art systems are not suitable for production and use in the developing world.

It is an object of the present invention to provide a low-cost, increased efficiency flywheel apparatus suitable for storing energy, having minimum run-down losses, in addition to being easily maintainable without the need for specialist tools or a high technology workshop.

### SUMMARY OF THE INVENTION

In accordance with a first aspect of the present invention, a flywheel apparatus suitable for storing energy having a low friction bearing solution is provided. The apparatus comprises a housing unit having a base; a flywheel assembly mounted within the housing unit, the assembly comprising a flywheel supported by a rotatable axle arranged to enable rotation of the assembly within the housing unit, the axle defining an axis of rotation. The apparatus further comprises stabilising means located within the housing unit arranged to stabilise rotation of the flywheel assembly about the rotation axis, and levitation means arranged to levitate the flywheel assembly above the base of the housing unit, to create a clearance between the flywheel assembly and the base of the housing unit.

An advantage provided by the present invention is that frictional losses resulting from rotation of the flywheel assembly are minimised, since the weight component of the assembly is supported by the levitation means, on the basis of a generated repulsive force.

As a result, there is no contact between the base of the housing unit and the rotating axle, and no associated dynamic frictional loses.

In accordance with an embodiment of the present invention, the axis of rotation may be substantially aligned in a vertical orientation, and the flywheel assembly rotates in a plane oriented perpendicular to the axis of rotation.

Additionally, the flywheel apparatus may comprise induction means arranged to generate a torque on the flywheel assembly, the torque being generated by induction. The induction means may comprise a rotor provided on the flywheel assembly; a stator provided on the housing unit; and an electrical current input means operatively connected to the stator, and arranged to input an AC (alternating) current within the stator. The input AC current induces an electromagnetic torque on the rotor, which in turn rotates the flywheel assembly.

An advantage associated with this embodiment is that the flywheel apparatus may have two principle modes of operation—as an electrical motor, and as an electrical generator. The apparatus may operate as an electrical motor when AC current is input in the stator, storing the input electrical energy as rotational kinetic energy in the rotating flywheel assembly. Similarly, the apparatus may also operate as an electrical generator. In this mode of operation, rotation of the flywheel assembly induces an output AC current in the stator.

In the electrical motor mode of operation, input electrical power provided to a stator comprised within the housing unit, induces a torque on a rotor, which comprises a permanent magnet. The rotor is attached to the axle. The induced torque results in a rotation of the rotor, which in turn causes rotation of the flywheel, thereby allowing input electrical power to be stored as rotational kinetic energy in the rotating flywheel.

In the electrical generator mode of operation, rotation of the rotor comprising the permanent magnet, induces an output electrical current in the stator, thereby converting the stored rotational kinetic energy within the flywheel into output electrical power.

The flywheel apparatus may be operatively connected to electrical power conversion means, the power conversion means being arranged to convert direct current (DC) to alternating current (AC) and vice versa.

The levitation means may comprise a first magnet provided on the base of the housing unit, and a second magnet provided on the flywheel assembly. The first and second magnet may be arranged relative to one another, such that like magnetic poles of the first and second magnet face each other. Alternatively, each of the two magnets may be assemblies of smaller magnets since this may enhance performance or reduce manufacturing costs. The repulsive force generated between the two magnets provides the required levitation to support the weight of the flywheel. The provided levitation ensures that a clearance is established between the flywheel axle and the base of the housing unit.

In an embodiment of the present invention, at least one of the first and second magnets may be a permanent magnet.

In an embodiment of the present invention, the permanent magnet may be a Neodymium magnet.

In an embodiment of the present invention, the stabilising means may comprise one or more bearings. In this way, rotational precession of the vertically aligned axle may be minimised by the one or more bearings. Preferably, the one or more bearings may be laterally affixed to the walls of the housing unit, and may be arranged to maintain the rotating axle in a substantially vertical orientation.

Alternatively, the one or more bearings may be rolling element bearings.

In an embodiment of the present invention, soft-element means may be provided between the stabilising means and the housing unit. The soft-element means may be arranged to allow off-axis rotation of the flywheel assembly.

In a preferred embodiment, the soft-element means may be affixed between the walls of the housing unit and the rolling element bearings. An advantage provided by the soft-element bearings is that they compensate for any out of balance, or off-geometric axis rotation of the flywheel about the axle. In such an embodiment the flywheel may not require balancing, or the balance tolerance may be reduced since the flywheel may rotate substantially about a rotation axis passing through its true centre of gravity, which may be different from the geometric axis as defined by the centres of the shaft at the point of the rolling element bearings. In such an embodiment, effectively the bearings themselves orbit around the axis of rotation but large forces are not generated since the bearings are located in soft housings.

Optionally, the flywheel apparatus may be housed within a hermetically sealed housing unit.

Additionally, a means for selectively varying the atmospheric conditions within the housing unit may be provided. This allows the atmospheric conditions within the housing unit to be selectively controlled to decrease windage losses.

The means for selectively varying the atmospheric conditions within the housing unit may be arranged to selectively vary either pressure, or the type of gas within the hermetic housing unit.

Alternative embodiments of the present invention may comprise vacuum pump means arranged to generate a vacuum environment within the housing unit. Operation of the flywheel within a vacuum minimises windage losses.

Alternatively, the hermetic housing unit may comprise a gas having a molecular weight less than air. Use of gasses lighter than air also advantageously decrease windage losses.

In embodiments of the present invention, the controllable atmosphere may be comprised of either Helium (He) or Hydrogen (H). In such embodiments, care is taken to ensure the conductivity of the gas does not compromise operation of the flywheel apparatus as a motor-generator.

Embodiments of the present invention may comprise a flywheel assembly comprising one or more discs attached to the axle. Use of one or more discs is preferable and beneficial, since in the event of a failure due to a crack forming in the disc as a result of fatigue or poor manufacture, only one fraction of the energy of the flywheel is released.

The present invention may be provided with attachment means for attaching the one or more discs to the flywheel assembly.

In alternative embodiments, the attachment means may comprise a hollow hub attached to the rotatable axle. The hub comprises securing means for attaching one or more discs to an exterior surface of the hub. The securing means may be arranged to deform to maintain contact with the ore or more discs when the hub is subjected to a centrifugal force.

The hub may comprise one or more weights arranged along an internal surface of the hub. In preferred embodiments, the hub has a bell shape.

Use of a bell-shaped hub is advantageous insofar as it enables the hub to expand without being constrained, when subjected to a centrifugal force. This expansion may be facilitated by means of internal weights distributed within the inside of the bell-shaped hub. The weights may consist of any dense material which is either mechanically weak such as lead, or has been slotted to remove or reduce its hoop stiffness to ensure contact is maintained between the weights and the hub.

For example, the weights may be manufactured from steel. However, given that steel has a relatively high hoop stiffness, in such embodiments the steel weights may be slotted, such that the centrifugal load bears onto the inside of the hub bell and forces the hub outwards to maintain contact with the discs.

The weights may have a uniform shape. Alternatively, the shape of the weights may be varied to ensure that all of the discs remain in contact with the hub during rotation of the flywheel, at all rotational speeds up to the maximum allowable rotational speed of the flywheel.

An advantage associated with such embodiments is that the elastically deformable hub ensures that contact between the one or more discs and the axle is maintained even as the one or more discs elastically deform, when subjected to a large centrifugal force during rotation of the flywheel assembly.

Alternative embodiments of the present invention may comprise protective means arranged to decrease the likelihood of stress fractures forming in the one or more discs. An advantage associated with such embodiments is that this allows the flywheel to operate at greater speeds and consequently to store more energy.

Preferably, the protective means may be comprised of a material having a high stress tolerance. For example, in certain embodiments the material may be glass fibre. The protective means is used to reinforce the discs and decrease the likelihood of rupturing due to stress fractures forming in the one or more discs. Alternatively, carbon fibre may be used.

In alternative embodiments, the protective means may comprise a circular-shaped protective sleeve encapsulating the one or more discs.

In preferred embodiments of the present invention, when operating in the electrical generator mode of operation, the stator may be arranged to provide a substantially balanced three-phase AC electrical power output, although different numbers of phases may be beneficial.

A second aspect of the present invention relates to a system comprising the aforementioned flywheel apparatus operatively connected to an electrical power generating apparatus. Use of the aforementioned flywheel apparatus in this manner, enables the electrical power generated by the electrical power generating means to be stored as rotational kinetic energy in the flywheel apparatus.

A third aspect of the present invention relates to a system comprising the aforementioned flywheel apparatus operatively connected to an electrical power consuming apparatus. Use of the aforementioned flywheel apparatus in this manner, enables the rotational kinetic energy stored in the flywheel to be converted to electrical power for use by the consuming apparatus.

A fourth aspect of the present invention relates to a method of supporting a flywheel assembly comprised within a housing unit, the housing unit having a base, the flywheel assembly comprising a flywheel supported by a rotatable axle arranged to enable rotation of the flywheel within the housing unit. The axle defines an axis of rotation. The method comprises stabilising the flywheel assembly in a plane perpendicular to the axis of rotation, and levitating the flywheel assembly above the base of the housing unit to create a clearance between the flywheel assembly and the base of the housing unit. The levitation is oriented in a direction along the axis of rotation. An advantage of this method is that dynamic frictional losses are minimised since the majority of the weight component is supported by the levitation means.

The second, third and fourth aspect of the invention may also comprise the preferred features of the first aspect of the invention.

As described above, the flywheel apparatus of the present invention may be used as an energy storage system. Use of the flywheel apparatus as an energy storage system is advantageous in that it can offer a life of several thousand cycles, and unlike an electrochemical storage solution where capacitance decreases with use, the amount of energy which can be stored remains constant. Furthermore, the present solution can be serviced and maintained in relatively basic workshop facilities.

The present invention will be of particular benefit in developing countries where use of traditional electrochemical energy storage solutions is expensive, due to a lack of resources required to produce and maintain the optimal functioning of such storage solutions. The presently provided storage solution is not subject to these restrictions, and can be manufactured locally with relative ease, when compared to electrochemical storage solutions, which require special chemical processing and manufacturing plants to produce such storage systems to the required quality.

### BRIEF DESCRIPTION OF THE DRAWINGS

FIG. 1 illustrates a schematic cross-sectional view of a flywheel apparatus operatively connected to a power input and output device in accordance with an embodiment of the present invention;

FIG. 2 illustrates a schematic cross-sectional view of an alternative embodiment of the flywheel apparatus, featuring a flywheel assembly comprising an extendable hub;

FIG. 3 illustrates a cross-sectional profile of a weight used to line the interior surface of the extendable hub illustrated in FIG. 2, in accordance with an embodiment of the present invention;

FIG. 4 illustrates an alternative plan view of a weight used to line the interior surface of the extendable hub illustrated in FIG. 2, in accordance with an alternative embodiment of the present invention.

### DETAILED DESCRIPTION

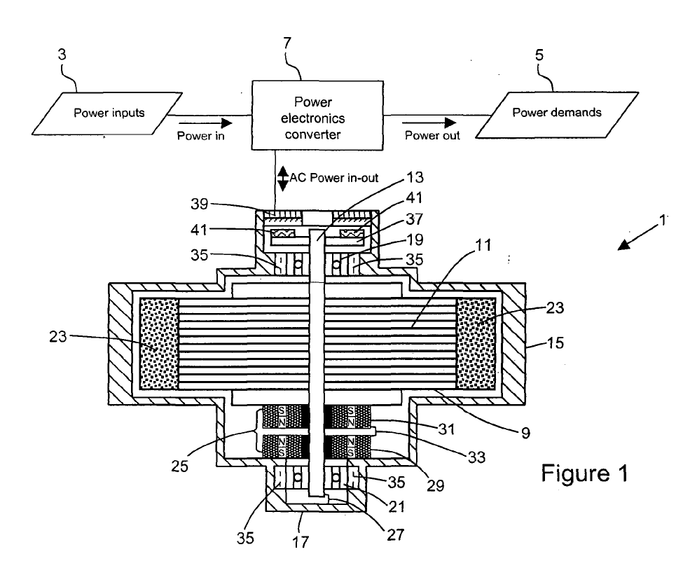

FIG. 1 illustrates a flywheel apparatus 1 in accordance with an embodiment of the present invention, operatively connected to a power input device 3 and a power output device 5, via a power electronics converter 7.

The flywheel apparatus 1 comprises a flywheel assembly, the assembly comprising a flywheel rotor 9, which may comprise a stack of one or more thin steel discs 11 in contact with a shaft/axle 13. Henceforth, references to the flywheel assembly refer to the combined flywheel rotor 9, and axle 13 apparatus. The flywheel assembly 9, 13 is contained in a housing unit/casing 15 (henceforth simply referred to as a housing unit), the housing unit 15 having a base 17. The housing unit 15 provides support for stabilising means, which in the illustrated embodiment comprise bearings 19, 21. The stabilising means stabilise the rotating flywheel assembly 9, 13, and ensure that the rotational axis is maintained in a substantially vertical orientation.

Preferably, the one or more thin steel discs 11 are readily removable from the shaft/axle 13. In preferred embodiments, the attachment means for attaching the one or more discs 11 to the shaft/axle 13 may comprise an interference fit. The flywheel assembly 9, 13 may be provided with clamping means (not illustrated in FIG. 1), which by means of an interference fit attach the one or more thin discs 11 to the assembly 9, 13.

The housing unit 15 provides protection in the event of a rotor failure and also provides a sealed environment to allow the internal volume of the housing unit 15 to be partially evacuated or filled with a lower density gas for reducing windage losses. The skilled reader will appreciate that use of the term “windage losses” in the present description relates to frictional losses between a gas (such as air) and an object, when there is relative movement between the object and the gas.

In preferred embodiments the flywheel rotor 9 is provided with a protective means 23 arranged to decrease the likelihood of stress fractures forming in the flywheel rotor 9, and the protective means 23 is comprised of a material having a high stress tolerance.

During operation of the flywheel assembly 9, 13 (i.e. as the flywheel assembly is in rotation), the discs 11 may be subjected to significant stresses resulting from the centrifugal force. Such stresses may cause structural deformations in the discs 11, which may ultimately result in the formation of stress fractures in the discs 11. FIG. 1 illustrates an embodiment featuring a protective means 23 comprising a cylindrically shaped sleeve. The sleeve is arranged around the one or more discs 11, and helps to prevent rupturing of the discs 11 of the flywheel rotor 9, resulting from stress fractures due to the rotational forces the discs 11 are subjected to.

Preferably, the protective means 23 may be comprised of a glass fibre material, or a carbon fibre material. However, alternative materials having high stress tolerances may also be used.

In alternative embodiments, the discs 1 1 may be individually coated with protective means.

The weight of the flywheel assembly 9, 13, is supported by levitation means 25. The levitation means 25 are arranged to levitate the flywheel assembly 9, 13 above the base 17 of the housing unit, in order to create a clearance 27 between the flywheel assembly 9, 13 and the base 17 of the housing unit.

In the embodiment illustrated in FIG. 1, the levitation means 25 is comprised of a first magnet 29 provided on the base 17 of the housing unit, and a second magnet 31 provided on the flywheel assembly 9, 13. Specifically, the first magnet 29 relates to a stationary permanent magnet magnetised in a vertical direction (i.e. parallel to the rotation axis), provided on the base 17 of the housing unit; and the second magnet 31 relates to a permanent magnet also magnetised in a vertical direction (i.e. parallel to the rotation axis). The magnets 29, 31 are oriented such that their magnetic poles are facing like to like to create an opposing, repulsive force. This repulsive force levitates the flywheel assembly 9, 13 leaving a small axial clearance 33 between the magnets 29, 31, and also ensures that a small axial clearance 27 is established between the shaft/axle 13 and the base 17 of the housing unit 15.

In alternative embodiments, the levitation means 25 may comprise non-permanent magnets, such as electro-magnets, or any other means for generating a sufficiently strong force to levitate the flywheel assembly 9, 13, and create an axial clearance 27 between the housing unit 15 and the flywheel assembly 9, 13. Equally, the functionality provided by the two magnets 29, 31 may be provided by a plurality of magnets, since such an arrangement may enhance performance, and/or reduce manufacturing costs. Such alternative embodiments are envisaged and fall within the scope of the present invention.

The embodiment illustrated in FIG. 1 , depicts a stabilising means comprised of two rolling element bearings 19, 21. The shaft/axle 13 is mounted in the two rolling element bearings 19, 21 which provide a small radial force to maintain the flywheel rotor 9 in equilibrium, and to minimise any rotational precession of the shaft/axle 13.

In alternative embodiments, the bearings 19 and 21 may be mounted in soft elements 35. The term “soft elements” is used in the present description to refer to any deformable apparatus, which may be placed between the bearings 19, 21 and the housing unit 15, arranged to allow off axis rotation of the flywheel assembly 9, 13. The soft elements 35 reduce the dynamic out of balance loads causing the flywheel assembly to rotate off axis, and consequently, use of soft elements 35 reduces frictional losses between the rotating shaft/axle 13 and the rolling element bearings 19, 21, by allowing the flywheel apparatus 9, 13 to rotate about its true centre of gravity which may be slightly different to the geometric axis of the shaft/axle 13 subject to the quality of balancing.

The skilled reader will appreciate that the functionality afforded by the stabilising means may be provided by a plurality of different apparatus, and such alternative embodiments fall within the scope of the present invention.

Preferably, the flywheel apparatus 1 comprises a motor-generator unit, the motor-generator unit being comprised of a rotor 37 provided on the flywheel assembly 9, 13, and a stator 39 provided on the housing unit 15. Electrical power is supplied and extracted from the flywheel via this motor-generator unit. In operation, the flywheel apparatus 1 has two modes of operation, as an electrical motor and as an electrical generator, which are described in further detail below.

Preferably, the rotor 35 may comprise one or more permanent magnets 41, whilst the stator 39 may be comprised of an electrically conductive coil having a plurality of windings. Although an axial flux permanent magnet 41 type device is illustrated in FIG. 1, it is clear that other topologies and types of magnet such as radial flux and types including induction or switched reluctance could equally be used in the motor-generator unit. Such alternative embodiments are envisaged, and fall within the scope of the present invention.

When operating in the electrical-motor mode of operation, electrical energy input into the stator 39, is stored in the flywheel apparatus as rotational kinetic energy in the rotating flywheel assembly 9, 13. This is achieved by inducing a torque on the rotor 37 by induction. The induced torque accelerates the rotor 37, and consequently the entire flywheel assembly 9, 13 is accelerated. Since the rotor 37 is operatively connected to the shaft/axle 13, which itself is connected to the flywheel 9, any rotation induced in the rotor 37, rotates the flywheel 9, by virtue of the rotor 37 being operatively connected to the shared shaft/axle 13.

Since use of the principle of magnetic induction for the operation of electrical generators is widely known, (e.g. any university level electromagnetism textbook), no further discussion of the generator mode of operation is provided herein.

The input electrical energy is provided by an optional power electronics converter 7, which transmits power from power sources 3. Power electronics converter 7 also comprises means for converting an input DC electrical current signal into an AC electrical current signal for input into the stator 37, required to induce a torque on the rotor 37. Power sources 13 may be, but not limited to solar voltaic cells, wind turbine generators, engines, or any other electrical power generating device.

When the flywheel apparatus 1 is operating in the electrical-generator mode of operation, power is extracted from the rotating flywheel assembly 9, 13 by the motor-generator unit, comprising the rotor 37 and the stator 39. In this mode of operation an AC electrical current is induced in the stator 39, due to the time-varying magnetic flux resulting from rotation of the one or more magnets 41 provided on the rotor 37, the rotation being driven by the rotating flywheel assembly 9, 13. AC electrical current induced in the stator 39 is subsequently output to power demands 5, via the power electronics converter 7. In preferred embodiments, the induced electrical power is a three-phase AC current.

However, alternative phase AC currents may also be generated where required. When the flywheel apparatus 1 is operating in the electrical-generator mode of operation, the power electronics converter 7 may provide the additional functionality of ensuring a constant voltage, and current signal profile are output to power demands 5. The voltage and AC current induced in the stator 39 will in part be conditioned by the rotational speed of the flywheel apparatus. Accordingly, in use, the induced current and voltage signal profile (including the electrical power signal frequency) is likely to vary as the rotational speed of the flywheel apparatus 1 varies. Power electronics converter 7 may further comprise means for outputting a current and voltage having a constant signal profile, irrespective of the input electrical power signal profile, ensuring that a usable electrical power signal is output to power demands 5.

Power demands 5 may relate, but are not limited to lights, such as light emitting diodes or fluorescents devices, radios, televisions, computers and charging for mobile phones, or any other device requiring electrical power.

In preferred embodiments the motor-generator (i.e. comprising rotor 37 and stator 39) may additionally comprise one or more semi-conductor switches. The semi-conductor switches may be selected such that when the nominal voltage across the stator 39 raises above a defined threshold value, the flywheel apparatus 1 switches between either a charging (electrical motor mode of operation), or discharging (electrical generator mode of operation) mode of operation.

To decrease windage losses, in preferred embodiments the housing unit 15 is hermetically sealed, allowing for rotation of the flywheel assembly 9, 13 within a controlled closed atmospheric environment. Additionally, the flywheel apparatus 1 may comprise means for selectively controlling the atmospheric conditions within the housing unit 15. Such means might comprise a vacuum pump for use in creating a vacuum within the housing unit 15, or any other type of pump apparatus for selectively controlling the pressure within the housing unit 15. Preferably, once the vacuum has been created, the housing unit 15 may be sealed and the pump removed, until such time that leakage creates the need for recreating the vacuum.

Equally, the means for selectively controlling the atmospheric conditions within the housing unit 15 may comprise selectively controlling the type of gas within the housing unit 15. For example, the housing unit 15 may be filled with a gas having a lower molecular weight than air, such as either Hydrogen, or Helium. Rotation of the flywheel assembly 9, 13 in a lighter gas, advantageously results in lower windage losses, when compared with the windage losses associated with rotation in air.

In a preferred embodiment the permanent magnets 29, 31 may be Neodymium magnets, or any other permanent magnets capable of generating a suitably strong repulsive magnetic force for levitating the flywheel assembly 9, 13. Selection of the type of the permanent magnets 29, 31 will, in part, be dependent on the weight of the flywheel assembly 9, 13 requiring levitation.

In preferred embodiments it is envisaged that the flywheel rotor 9 has a diameter of 300 mm and that the thickness of the stack of plates 11 is 100 mm. However, in alternative embodiments the dimensions of the flywheel may vary significantly from the provided values, and do not impact on the functionality of the flywheel.

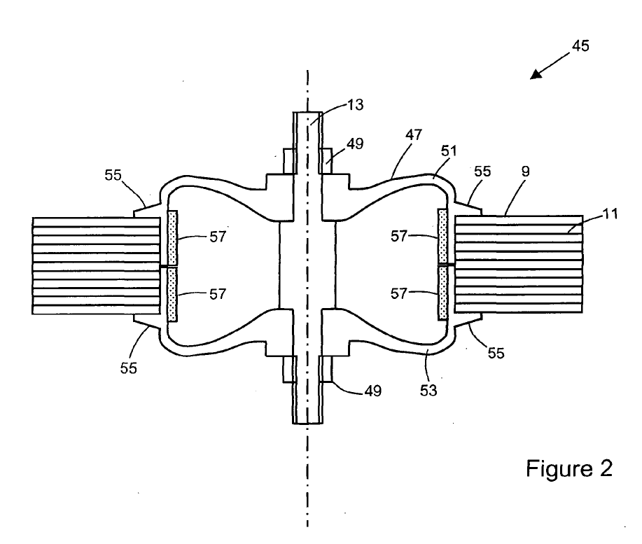

FIG. 2 illustrates a cross-section view of an alternative embodiment 45 of the flywheel assembly 9, 13 illustrated in FIG. 1. In the following discussion of FIG. 2, the same numbering as used in FIG. 1 will be used to indicate like components. The significant difference with previously described embodiments is that the attachment means arranged to attach the one or more discs 11 to the flywheel assembly 9, 13, now comprises a hollow hub 47.

The hub 47 may be attached to the axle 13 by clamping means 49. The hub 47 comprises securing means 55 arranged to attach the one or more discs 11 to the exterior surface of the hub 47. Preferably, the hub 47 may be comprised of two separable components, comprising an upper portion 51 and a lower portion 53. In this way, the discs 11 may be readily accessed for maintenance purposes, by removing one of the separable hub components 51, 53.

In use, the hub 47 is arranged to deform, such that the securing means 55 maintain contact with the one or more discs 11. When subjected to a sufficiently high centrifugal force during rotation of the flywheel assembly 45, the discs 11 may deform as a result of ensuing stresses in the discs 11. One unwanted consequence of such deformation is that the attachment between the discs 11 and the axle 13 may become disrupted, severely affecting the balance of the flywheel assembly, and potentially damaging the assembly due to excessive vibrations.

One way of resolving this problem is to permanently attach the one or more discs 11 to the axle 13, for example by welding. However, this is not an ideal solution for use in a low technology workshop, insofar as any maintenance of the discs requires breaking the weld. Welding may also weaken the structural integrity of the discs, increasing the likelihood of cracks developing.

Use of the hollow hub 47 illustrated in FIG. 2, provides an improved solution to the above described problem. Effectively, the hollow hub 47 is manufactured from a material having similar, if not identical structural characteristics as the discs 11. In preferred embodiments the hub 47 may be manufactured from the same material as the discs 11. In use, the hub 47 is configured to deform at substantially the same rate as the discs 11.

Due to the bell-shape of the hub 47, as the hub deforms radially under strain resulting from the centrifugal force, contact with the discs 11 is maintained in the radial direction. Maintaining contact with the one or more discs 11 is important to ensure the flywheel assembly 9, 13, including the hub 47 remains balanced in operation.

To facilitate the deformation of the hub 46, in preferred embodiments, the internal surface of the hub 47 may be lined with one or more weights 57. The weights 57 help provoke structural deformation of the hub 47 during operation of the flywheel assembly 45. In particular, the weights 57 facilitate overcoming the hoop stiffness of the hub 47, causing it to deform radially outwards more than it would otherwise, and hence maintain contact with the discs 11.

In the present context, the hoop stiffness relates to the threshold force per unit area required to provoke a structural deformation in an object. Accordingly, a radial force per unit area in the hub 47 greater than the hoop stiffness will provoke a radially outward structural deformation in the hub 47.

The skilled reader will appreciate that the clamping means 49 facilitate access to both the discs and the hub 51 for maintenance purposes. Accordingly, the separable hub components 51, 53 may be readily maintained or replaced after prolonged use, once the error free operation of the flywheel assembly 45, due to structural degradation of the hub 47 is no longer possible.

The applied centrifugal force at any one point on the hub 47, may be varied by varying the weight 57. Equally, in embodiments where a non-uniform centrifugal force is required to ensure that the hub 47 deforms in a uniform fashion to maintain radial contact with all the discs 11, weights 57 having non-uniform shapes may be used.

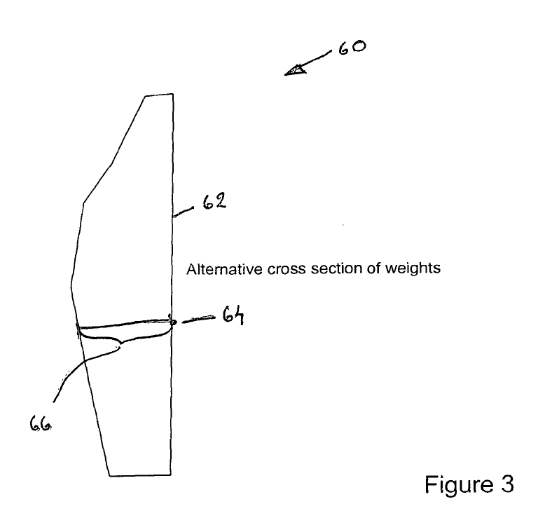

FIG. 3 illustrates a vertical (i.e. in an axial direction) cross-section of a weight 60 having a non-uniform shape, for use in an embodiment of the present invention. The weight 60 is arranged along the internal surface of the hub 47 illustrated in FIG. 2, with the face 62 in contact with the hub's internal surface. The centrifugal force applied on the internal surface of the hub 47 at any one point, will be partly dependent on the radial thickness of the weight 60 in contact with the subject point. For example, the centrifugal force exerted on the internal surface of the hub 47 at a point 64 in contact with the weight 60, will be in part dependent on the radial thickness 66 of the weight 60 at the contact point 64. Accordingly, by selectively varying the cross-sectional thickness of the weight 60, the applied centrifugal force on the internal surface of the hub 47 may be varied. This can be used to ensure that a uniform deformation of the hub 47 occurs during operation of the flywheel assembly 45.

For example, the surface thickness of the hub 47 may vary. To ensure uniform deformation of the hub 47, may require selecting a weight having a non-uniform radial thickness, arranged such that those parts of the weight 60 having a larger radial thickness are in contact with those parts of the hub 47 having a larger thickness. In this way, the magnitude of the centrifugal force applied to the hub 47 may be varied to ensure uniform deformation of the hub 47, by compensating for any non-uniformity in the hub due to its shape. Similarly, the cross-sectional shape of the weight 60 may be selected to provoke a non-uniform deformation of the hub 47, where desirable.

It is to be appreciated that in order for the weights 57, illustrated in FIG. 2, to facilitate deformation of hub 47, contact must be maintained between the internal surface of the hub 47 and the weights 57. Accordingly, when subjected to a centrifugal force, the weights 57 must deform proportionally to the radial deformation of the hub 47. Accordingly, and depending on the material selected, it may be necessary to slot the surface of the weights to weaken the structural strength of the weight 57, to facilitate radial deformation of the weights 57, to ensure contact between the hub 57 and the weights 57 is maintained.

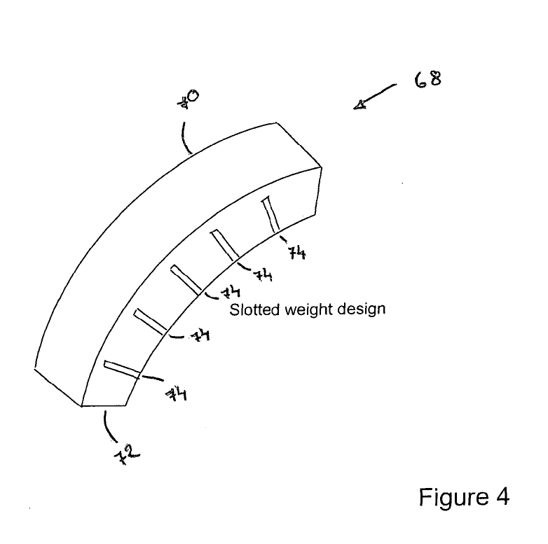

FIG. 4 illustrates a plan view (i.e. taken from above) of a slotted weight design 68, in accordance with an embodiment of the present invention. The external surface 70 is placed in contact with the internal surface of the hub 47, whilst the internal surface 72 is radially inward facing. The internal surface 72 comprises one or more slots 74, which may be incisions in the internal surface 72, which weaken the structural strength of the weight 68. In operation (i.e. whilst the flywheel assembly 45 is rotating), the slots 74 facilitate the radially outward deformation of the weight 68, to ensure contact is maintained between the external surface 70 of the weight 68 and the internal surface of the hub 47.

The weights 57 illustrated in FIG. 2, and equivalently the weights 60 of FIG. 3, and weights 68 of FIG. 4 may be comprised of any dense materials. In embodiments where the material of the weight is very dense, such as steel, and has a very high hoop stiffness, a slotted weight design, such as illustrated in FIG. 4 may be required to maintain contact between the external surface of the weight and the internal surface of the hub 47, as the hub 47 deforms. Similarly, weights made from less dense materials, such as lead, which may be associated with a significantly lower hoop stiffness, may not require any structural amendments such as slotting.

In alternative embodiments of the present invention, the attachment means 55 for attaching the one or more discs 11 to the hub 47 may comprise an interference fit generated using a heat shrink, which may be obtained by heating the one or more discs 11 and cooling the hub 47. Cooling of the hub 47 may be achieved by use of liquid nitrogen.

The herein described embodiments of the invention are for illustrative purposes only, and are not limiting. Furthermore, alternative embodiments comprising any combination of features described herein are also envisaged and fall within the scope of the present invention.

1. A flywheel apparatus for use as an energy storage system, the apparatus comprising:
a housing unit having a base;
a flywheel assembly mounted within the housing unit, the assembly comprising a flywheel supported by a rotatable axle arranged to enable rotation of the assembly within the housing, the axle defining an axis of rotation;
stabilizing means located within the housing unit arranged to stabilize rotation of the flywheel assembly about the rotation axis; and
levitation means arranged to levitate the flywheel assembly above the base of the housing unit, in order to create a clearance between the flywheel assembly and the base of the housing unit.

2. The apparatus of claim 1, wherein the axis of rotation is substantially aligned in a vertical orientation, and the flywheel rotates in a plane oriented perpendicularly to the axis of rotation.

3. The apparatus of claim 1, further comprising induction means arranged to generate a torque on the flywheel assembly by induction, the induction means comprising:
a rotor provided on the flywheel assembly;
a stator provided on the housing unit;
electrical current input means operatively connected to the stator, and arranged to input an AC current within the stator, in order to generate the torque.

4. The apparatus of claim 3, further comprising electrical power conversion means operatively connected to the stator, and wherein the power conversion means is arranged to convert direct current (DC) to alternating current (AC) and vice versa.

5. The apparatus of claim 1, wherein the levitation means comprises: a first magnet provided on the base of the housing unit;
a second magnet provided on the flywheel assembly; wherein
the first and second magnet being arranged relative to one another, such that like magnetic poles of the first and second magnet face each other.

6. The apparatus of claim 5, wherein at least one of the first and second magnets is a permanent magnet.

7. The apparatus of claim 6, wherein the permanent magnet is a Neodymium magnet.

8. The apparatus of claim 1, wherein the stabilizing means comprises one or more bearings.

9. The apparatus of claim 8, wherein the one or more bearings are rolling element bearings.

10. The apparatus of claim 8, comprising soft-element means provided between the stabilizing means and the housing unit, the soft-element means being arranged to allow off-axis rotation of the flywheel assembly.

11. The apparatus of claim 1, wherein the housing unit is hermetically sealed.

12. The apparatus of claim 11, comprising means for selectively controlling the atmospheric conditions within the housing unit.

13. The apparatus of claim 12, wherein the means for selectively controlling the atmospheric conditions within the housing unit is arranged to selectively vary either of: a) pressure;
b) type of gas within the hermetic housing unit.

14. The apparatus of claim 11, comprising a vacuum pump means arranged to generate a vacuum environment within the housing unit.

15. The apparatus of claim 11, wherein the hermetic housing unit comprises a gas, the gas having a molecular weight less than air.

16. The apparatus of claim 15, wherein the housing unit comprises either of:
a) Helium (He);
b) Hydrogen (H).

17. The apparatus of claim 1, wherein the flywheel assembly comprises one or more discs attached to the axle.

18. The apparatus of claim 1, comprising attachment means for attaching one or more discs to the flywheel assembly.

19. The apparatus of claim 18, wherein the attachment means comprises a hollow hub attached to the rotatable axle, the hub comprising:
securing means for attaching one or more discs to an exterior surface of the hub, the securing means being arranged to deform to maintain contact with the one or more discs when the hub is subjected to a centrifugal force.

20. The apparatus of claim 19, wherein the hollow hub comprises one or more weights arranged along an internal surface of the hub.

21. The apparatus of claim 17, comprising protective means arranged to decrease the likelihood of stress fractures forming in the one or more discs.

22. The apparatus of claim 21, wherein the protective means is comprised of a material having a high stress tolerance.

23. The apparatus of claim 21, wherein the protective means comprises a circular-shaped protective sleeve encapsulating the one or more discs.

24. The apparatus of claim 21, wherein the protective means comprises a protective coating applied individually to each of the one or more discs.

25. The apparatus of claim 22, wherein the material of the protective means is a glass fibre.

26. The apparatus of claim 22, wherein the material of the protective means is a carbon fibre.

27. The flywheel apparatus of claim 3, arranged to generate an output electrical current by induction.

28. A system comprising the flywheel apparatus of claim 1 operatively connected to an electrical power generating apparatus.

29. A system comprising the flywheel apparatus of claim 1 operatively connected to an electrical power consuming apparatus.

30. A method of supporting a flywheel assembly comprised within a housing unit, the housing unit having a base, the flywheel assembly comprising a flywheel supported by a rotatable axle arranged to enable rotation of the flywheel within the housing unit, the axle defining an axis of rotation, the method comprising:
stabilizing the flywheel assembly in a plane perpendicular to the axis of rotation; and
levitating the flywheel assembly above the base of the housing unit to create a clearance between the flywheel assembly and the base of the housing unit, the levitation being oriented in a direction along the axis of rotation.
